(19) United States
(12) Patent Application Publication
(10) Pub. No.: US 2014/0304834 A1
(43) Pub. Date: Oct. 9, 2014

(54) Personalized Secure Data Access Techniques

(71) Applicant: Andrew Hulse, Medina, TX (US)

(72) Inventor: Andrew Hulse, Medina, TX (US)

(21) Appl. No.: 13/873,350

(22) Filed: Apr. 30, 2013

Related U.S. Application Data
(63) Continuation-in-part of application No. 13/252,994, filed on Oct. 4, 2011.

(51) Int. Cl. G06F 21/62

(52) U.S. Cl. CPC G06F 21/6245
USPC 726/28

(57) ABSTRACT

A technique for a user to access secure data in a PIN-like combination fashion that is substantially undetectable by a third party observer or keystroke tracking computer virus. The technique includes establishing a counter-combination of indicators that may be aligned with set indicators of a user's combination. The counter-combination indicators may be personalized indicators as an aid to the user in entering set indicators in a manner that may be largely undetectable to an observer.

### PRIORITY CLAIM/CROSS REFERENCE TO RELATED APPLICATION(S)

This Patent Document is a Continuation-In-Part claiming priority under 35 U.S.C. §120 to U.S. application Ser. No. 13/252,994, entitled “Data Encryption and Input System”, filed Oct. 4, 2011 and which in turn claims priority under 35 U.S.C. §119 to U.S. Provisional App. Ser. Nos. 61/390,115, 61/434,805 and 61/444,627, all of which are incorporated herein by reference in their entireties. This Patent Document further claims priority under 35 U.S.C. §119 to U.S. Provisional App. Ser. No. 61/390,115, filed May 31, 2012 which is also incorporated herein by reference in its entirety.

### BACKGROUND

Personal cyber security is of ever increasing significance in the modern world. Unlike concerns over forged signatures on checks and more traditional modes of identity theft, modern forms of such breaches may take place in more discrete and harder to detect manners. For example, stolen credit card information may be utilized by the thief or other unauthorized user over the phone or through a computer screen where such theft is much less detectable.

Fortunately, the degree of harm in such thefts is often prevented through the use of password and PIN (personal ID number) protections. So, for example, where a bank card or number is stolen, the thief must also possess the true owner's password or PIN in order to make use of the card. Indeed, after a few failed attempts at guessing the PIN at the ATM (automated teller machine), the card thief is likely to have achieved no more than invalidating the card to any further uses.

Unfortunately, the bank card as described above is often utilized in a public space. That is, the ATM is located where a passerby is able to witness the user's entry of PIN information. In fact, with the advent of smartphone cameras and video, a whole new area of identity theft is emerging which involves discrete recording of users as they input password or PIN information at locations such as an ATM. Once more, such public space concerns are quite widespread. For example, computer screens at the public library, bank card use at the grocery store, shared office spaces and other close quarters leave such user password or PIN information more susceptible to theft. In fact, even where the use of such information is at a personal computer in a private location, a computer virus may be tailored to monitor a user's keystroke pattern at a bank website and send the information to an offshore identity thief.

Of course, more traditional thefts of this nature exist such as the threat of stolen safe or high school locker combinations. However, in many ways the threat is much more pronounced in the case of today's password and PIN information. For example, such information is much more likely to be frequently used and in open public space as compared to a private safe combination. Once more the information may provide unfettered access to a user's life savings as opposed to a mere book in a high school locker.

Efforts have been undertaken to address the susceptibility of password and PIN information to susceptibility in public forum or computer virus thefts as described above. For example, in a banking context, a user may be asked a personal question in advance of entering PIN or password data to the host bank website, such as “What is your mother's maiden name?”.

Unfortunately, this added level or threshold of security may be of minimal value where the identity thief knows the user. Further, it presents no real barrier where the identity thief obtained the PIN or password data in a manner that also resulted in theft of an answer to such a personal information question. Indeed, in the public forum and computer virus examples described above, it would be commonplace that an answer to a personal data question would accompany the theft of the underlying PIN or password information.

Ultimately, the user and the legitimate host, such as the bank in the example above, are left with no better than a recurring need to address the theft issue. Regular computer virus checks, new bank cards and an ever-increasing volume of new PIN and password information for the user to remember are the practical result of such thefts. Once more, the amount of time and capital spent on third party policing of identity theft, whether government or privately funded, is a drain on resources that continues to grow at an escalating rate as the marketplace moves further and further, into the cyber realm.

### SUMMARY

Embodiments of techniques for accessing data through a graphical user interface are detailed herein. Certain embodiments may include aligning a first set indicator of a combination display with a personalized indicator of a counter-combination display. The paired alignment may be noted as valid through standard entry at the interface. This type of aligning may be repeated. For example, a second set indicator of the combination display may be aligned with another personalized indicator of a second counter-combination display. This second paired alignment may again be confirmed as valid through entry at the interface. Ultimately, multiple entries of such valid alignments may allow access to the secure data

### BRIEF DESCRIPTION OF THE DRAWINGS

FIG. 1 is a depiction of a touch screen graphical user interface (GUI) for employing an embodiment of a secure data access technique using combination and counter-combination dials.

FIG. 2A is a representation of another GUI with the combination and counter-combination dials ready for a first personalized paired alignment according to the technique of FIG. 1.

FIG. 2B is a representation of the GUI of FIG. 2A with the dials ready for a second personalized paired alignment following the first paired alignment.

FIG. 2C is a representation of the GUI of FIG. 2B with the dials ready for a third personalized paired alignment for finishing combination entry and completing the data access technique.

FIG. 3A is a representation of another GUI for an embodiment of an exclusively personalized secure access data technique and upon a first personalized paired alignment of adjacent inner and intermediate dials.

FIG. 3B is a representation of the GUI and embodiment of FIG. 3A upon a second personalized paired alignment of the intermediate dial with an outer additional dial.

FIG. 4A is a representation of a GUI for an embodiment of a secure access data technique employing multiple key charts.

FIG. 4B is a representation of a GUI for an embodiment of a secure access data technique employing a decoy dial set.

FIG. 5 is a representation of a GUI for an embodiment of a secure access data technique employing linear personalized combination pairings.

FIG. 6 is a flow-chart summarizing embodiments of employing secure data access techniques through graphical user interfaces utilizing personalized pairings.

### DETAILED DESCRIPTION

Embodiments are described with reference to certain techniques of displaying and aligning indicators of combinations and counter-combinations through a graphical user interface (GUI) in order to attain access to secure data. More specifically, a given set indicator of a combination may be paired with a personalized indicator of a counter-combination, the pairing noted, marked, or otherwise entered as valid and the process repeated with reference to another counter-combination and personalized indicator. In this manner, a combination code or sequence may be entered by a user through the GUI in a substantially undetectable manner by a third party that does not already have access to the combination code. That is, as detailed herein even watching the user make the entries fails to reveal the combination code to an onlooker or key-monitoring type virus.

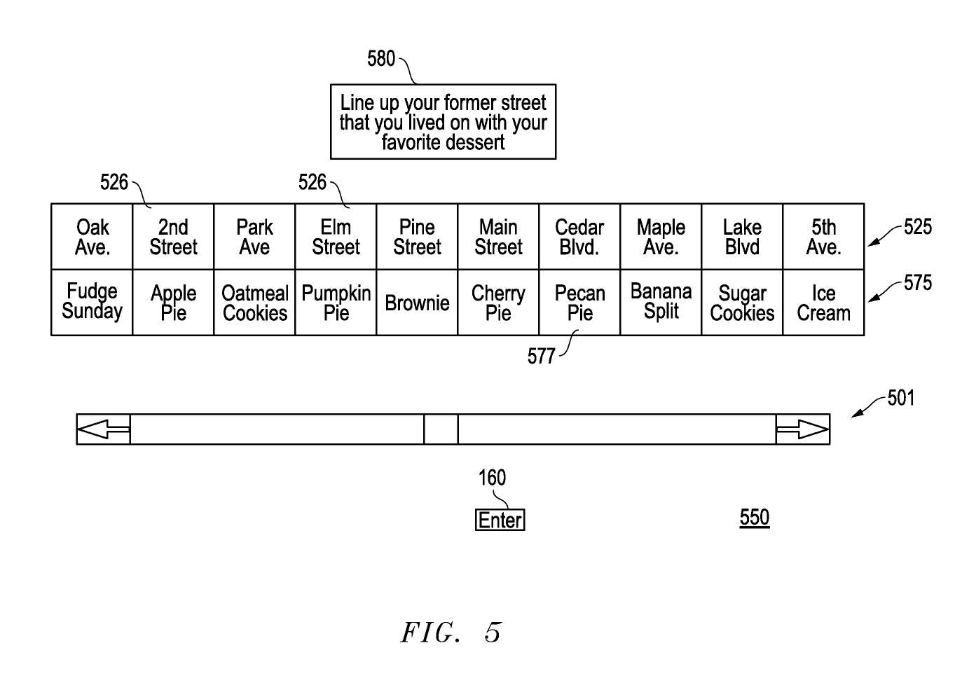

Example embodiments herein generally utilize dial-type combinations with set indicators which are graphically adjacent dial-type counter-combinations employing personalized indicators. However, the combinations and counter-combinations need not be of a dial variety (e.g. see FIG. 5). Indeed, so long as an initial pairing of a set indicator and personalized indicator is followed by another pairing of a set indicator with another personalized indicator from a new “counter-combination”, a novel degree of security is attained.

It is of note that embodiments herein are directed at generation of a new counter-combination for pairing with set indicators of the combination by way of the counter-combinations relating to personalized user data. For example, as detailed herein, one counter-combination may consist of personalized indicators in the form of possible user best friend names whereas the second counter-combination may utilize personalized indicators in the form of possible user favorite colors. In this manner, the user need not always have memorized or written recall of complete combination/counter-combination pairings but may rely to some degree on memory of his or her own personal history. To this extent, embodiments herein are similar but also supplemental to those detailed in U.S. patent application Ser. No. 13/252,994 where subsequent or “new” counter-combination dials or groupings are described as generated through a technique of randomization.

That is, in the parent '994 Application hereof, once a pairing is entered, the newness of the counter-combination dial may be created by randomization of its indicators (e.g. a set of seemingly arbitrary letters or numbers). Thus, the undetectable nature of password entry emerges as detailed throughout the '994 Application and herebelow. The present application expounds on this concept to clarify that different sets of personalized indicators may be utilized for the counter-combination dials (or groupings), not limited to seemingly arbitrary number sets. Thus, a new counter-combination dial may be presented by changing user personal topics (e.g. from best friend to favorite color). As a result, even though the use of combination/counter-combination pairings may appear to add complexity, for example to enter passwords, the reliance on a user's own personal historical information may substantially mitigate such complexity from the user's perspective as clarified further hereinbelow.

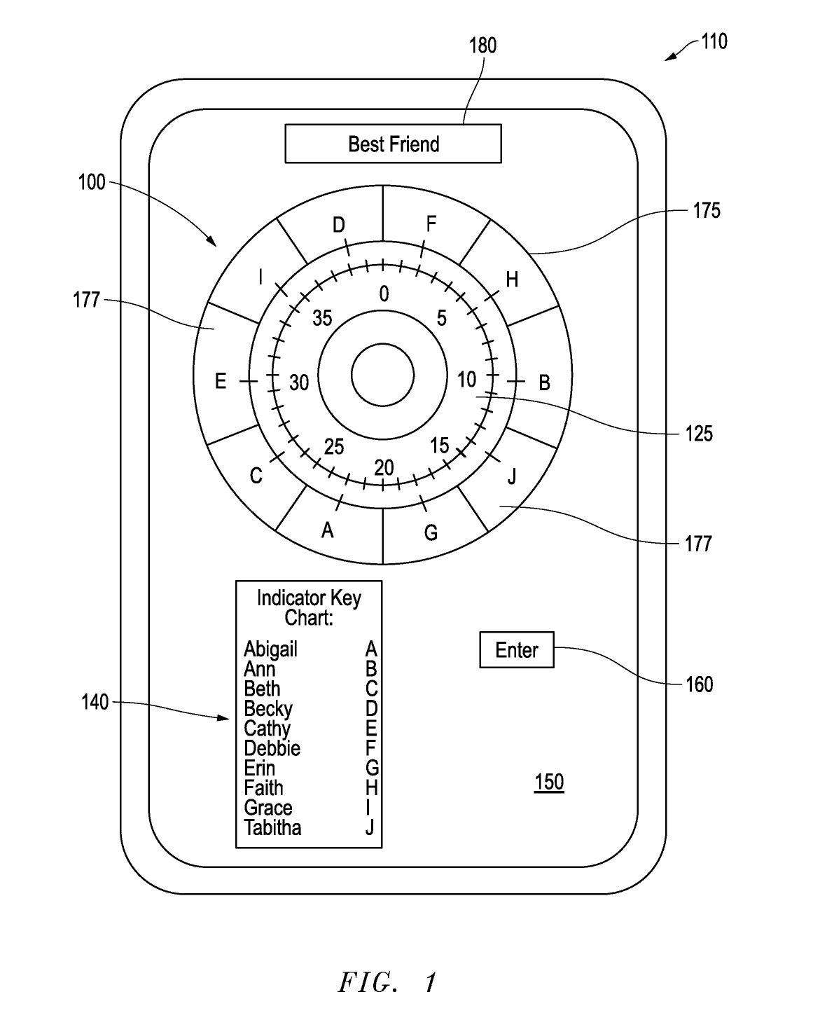

Referring now to FIG. 1, a touch screen graphical user interface (GUI) 150 is shown for employing an embodiment of a secure data access technique using a combination display 100 with combination 125 and counter-combination 175 dials. In this embodiment, the GUI 150 is presented on a tablet 110. Though, a touch screen smartphone or other similar display device may be utilized. Of course, in other embodiments, non-touch screen devices with computerized or digital displays may be utilized. Additionally, conventional laptop or desktop computers, airport, movie and other ticket kiosks, etc, may be suitable candidates for the technology as well. Regardless, the counter-combination dial 175 makes use of personalized indicators 177 that are configured for alignment with set indicators of the combination dial 125 (e.g. combination numbers 0-39) as detailed below.

Continuing with reference to FIG. 1, an example combination of 23-16-37 may be used for gaining access to secure data through the tablet interface 150 similar to a physical locker or padlock combination in the non-virtual world. That is, dial turning followed by pressing the enter button 160 may be used to sequentially enter 23, then 16, then 37 in order to gain access to secure data via the interface 150. However, a virtual world version of aligning the set indicator number of the combination dial 125 with an adjacently fixed marker is not employed. Instead, the set indicators, 23, 16, and 37 in this case, are sequentially aligned with various personalized indicators 177 of the counter-combination dial 175. In this manner, an onlooker or computer virus for example, which is tracking the user's selections, nevertheless remains substantially unable to ascertain what combination is actually being entered by the user as detailed further below.

As indicated above, rather than align the first set indicator 23 of the combination dial 125 with a fixed mark adjacent the dial 125, the user instead is asked to align the set indicator 23 with a personalized indicator 177 of the counter-combination dial 175. As detailed further below, personalized indicators 177 may be established ahead of time based on the user's own personal history. In the example shown in FIG. 1, a personal history topic 180 is presented along with an indicator key chart 140 to let the user know the specific alignment that is to be entered. More specifically, in the example of FIG. 1, the user is to align the first set indicator 23 of the combination dial 125 with a personalized indicator 177 of the counter-combination dial 175 that represents a female user's best friend. Thus, if “Beth” applies, then the alignment is to be made between 23 on the combination dial 125 and “C” on the counter-combination dial 175 followed by selecting the enter button 160.

Once the enter button 160 is pressed, a different personal history topic 180 and key chart 140 may be presented and the process repeated. Use of the dials 125, 175 in this manner prevents an onlooker from being able to ascertain what particular alignment is being made. That is, from the user's perspective an alignment is being made between 23 with C. However, from an onlooker's perspective 10 is being aligned with J, 35 is being aligned with D, and several other decoy alignments are also taking place. That is, an onlooker is unable to ascertain which is the true alignment that is actually being made. Further, guessing the true alignment at random would ultimately be of no realistic practical value. For example, remembering the 10/J decoy alignment would be of no use when, on subsequent attempts to enter the first number of the combination, a different topic 180 and key chart 140 are presented. Indeed, in embodiments herein, once any valid alignment is entered (160), the counter-combination dial 175 may also be reshuffled in terms of letter positioning used for the personalized indicators 177. For example, the “C”, “J”, and every other letter may switch locations on the dial 175 after every time the enter button 160 is selected. Thus, tracking of valid alignments by an onlooker becomes a practically impossible undertaking as the user moves from entry to entry to entry.

The complexity may seem daunting to a hacker trying to lift the user's 23-16-37 combination in the example used here. At the same time however, the user is unlikely to be confused or burdened down with a cumbersome amount of data to recall in order to make use of his own combination. That is, unlike the onlooker, the user need only recall the 23-16-37 combination along with his own self-completed personal history in order to make use of such a technique and access the underlying secure data. For example, where the underlying data is the user's own bank account information, the interface 150 may be that displayed by a bank website or tablet application (“app”). Thus, through a questionnaire, the user may separately establish personal history data with the host banking institution such as follows:

User Personal Data Sheet

1) Personal Facts:

| | | |
|---|---|---|
| a. | What is your favorite month? | October |
| b. | What is your favorite color? | Orange |
| c. | What is your dream vacation? | Bora Bora |

2) Historical Facts:

| | | |
|---|---|---|
| a. | What street did you grow up on? | Oak St. |
| b. | What is your mother's maiden name? | Doe |
| c. | What was your first job? | Paper Boy |
| d. | What was the name of your childhood pet? | Snoopy |
| e. | What was your area code in high school? | 817 |
| f. | What was the name of your best friend in grade school? | Beth |

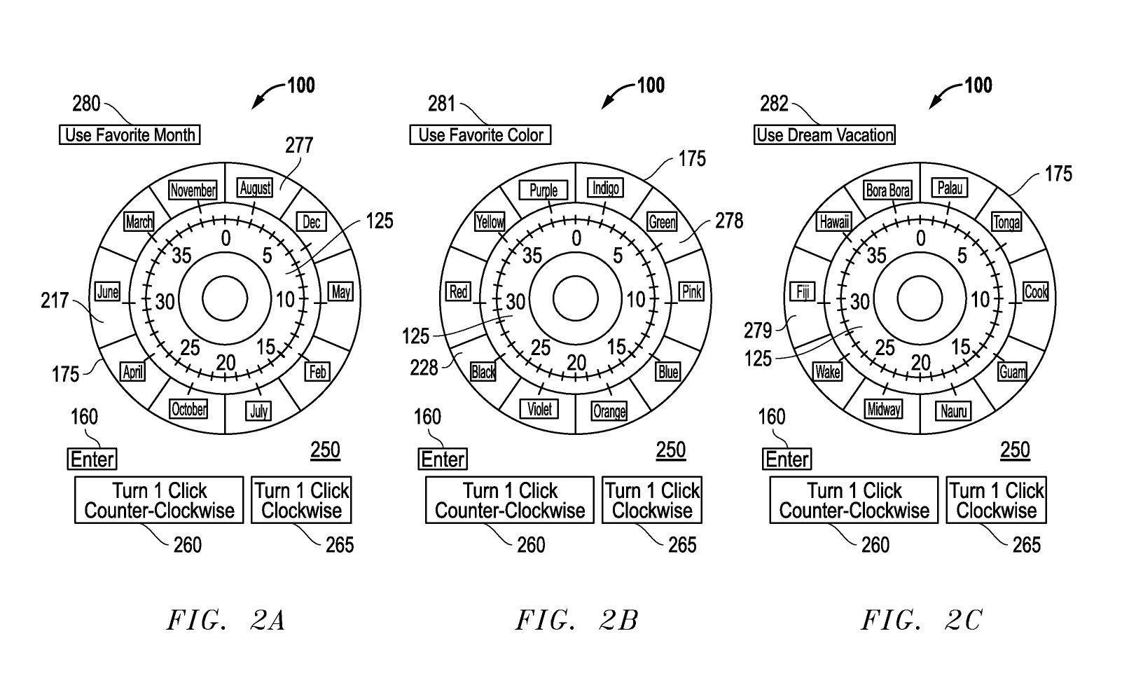

Of course, many other categories of user personal facts may be provided to the host institution for sake of generating any number of different indicator key charts 140. Additionally, the chart 140 may be replaced by simply placing the information directly at the personalized indicators 177 where practical (see indicators 277 of FIGS. 2A-2C). Regardless, from the user's perspective, mere reference to the topic 180 indicator of the GUI 150 provides sufficient guidance as to the appropriate alignment for each set indicator (i.e. combination number). In the example here, the first set indicator is 23 and the user's best friend from grade school was “Beth”. Thus, with no more than recollection of a best friend's name and the first number to the combination being 23, the user is able to align and enter this selection. At the same time, however, this is achieved simultaneously with numerous decoy alignments of non-best friends. Thus, an onlooker remains unable to tell what actual alignment was actually selected by the user.

It is of note that embodiments of secure access data techniques as detailed herein may be particularly well suited for use in public spaces such as with a computer at a public library, an airline ticket kiosk, or an ATM. That is, with such public space usage, any given user is unlikely to dominate usage of the device and/or GUI 150. As a result, an onlooker or virus tracking user inputs would be subject to a variety of different intervening users and different user combinations being utilized by the same device. Thus, the odds of tracking a given user's inputs long enough to gather any usable code cracking information would be nearly, if not completely, impossible with such public use devices that employ techniques as described herein.

The interface 150 of FIG. 1 utilizes multiple dials 125, 175 as described hereinabove. In such a touch screen embodiment, the user may achieve the above described alignments by way of turning the inner combination dial 125 similar to a conventional padlock. However, in one embodiment the combination dial 125 may remain fixed while the user employs a finger to rotate the outer counter-combination dial 175 in order to achieve alignments. Once more, so as to prevent an onlooker from even witnessing a user's finger movements, the interface 150 may be configured for mouse-type or other input clicking of rotation buttons 260, 265 to attain alignments (see FIGS. 2A-2C).

Referring now to FIGS. 2A-2C a full sequence of entering a combination to gain access to secure data through a GUI 250 as described hereinabove is shown. That is FIG. 2A represents the entering of 23, FIG. 2B, the entering of 16 and 2C, the entering of 37. In the embodiment shown, the combination dial 125 remains fixed whereas the counter-combination dial 175 may be rotated by the user in order to attain the alignment. Further, in this particular embodiment, a mouse-clicking type of dial movement is utilized as opposed to touch screen interfacing. For example, mouse clicking of a clockwise 265 or counter-clockwise 260 button on the GUI 250 may be used to rotate the counter-combination dial 175 to the proper alignment Once a given personalized indicator 277, 278, 279 of this dial 175 is aligned with and the appropriate set indicator number of the combination dial 125, the selection may be entered at the enter button 160.

With specific reference to FIG. 2A, the first personalized paired alignment of 23 and the personalized indicator 277 of “October” is attained as described above in response to the user being presented with the “Favorite Month” topic 280. While the user and host or application are aware of the user's favorite month being October, a passerby would be unaware what particular alignment was actually being selected and entered. Further, the next time the first number of the combination, 23 in this example, is to be entered the topic 280 is likely to change to a new topic (e.g. 281 or 282 (see below)).

Indeed, moving to FIG. 2B, a new topic 281 is also presented as the second number of the combination is to be entered (16 in continuing with the same example). Specifically, FIG. 2B reveals that the counter-combination dial 175 is moved to allow alignment between a personalized indicator 278 of the user's favorite color “Orange” and 16. The alignment is made, the enter button 160 pressed and the counter-combination dial 175 made anew by presentation of the last topic 282, the user's “Dream Vacation”.

Thus, looking specifically at FIG. 2C, we can see that the user's dream vacation is “Bora Bora”, shown in the personalized indicator 279 that the user has aligned with 37, the last combination number. Of course, we only know this because we know the user's combination, 23-16-37, ahead of time. For a passerby viewing entry of the combination according to the technique described herein, there is no way of knowing due to the fact that almost every possible alignment between personalized indicators 277, 278, 279 and set numbers are complete decoys.

The GUI 150, 250 of the above example embodiments may include a host of additional features. For example, in addition to enter 160 or turn 260, 265 buttons, other entries are possible. These may include those such as “I Forgot My Favorite Month (or Color, etc)” so as to allow the user to present a new topic 180, 280, 281, 282. Additionally, dials 125, 175 may be moved by more manual single clicking as noted above or perhaps through slide control and/or with an auto-spin function that turns the dial until directed to stop by the user.

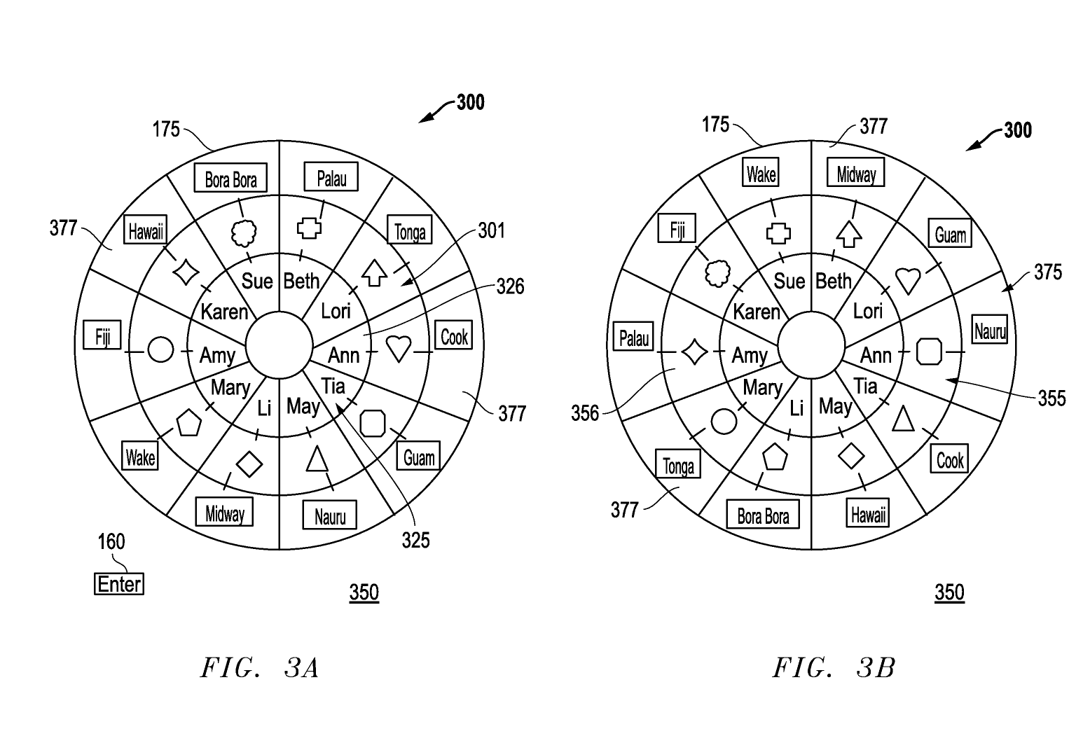

Referring now to FIGS. 3A and 3B, an exclusively personalized combination 300 is utilized through a GUI 350. That is, the number combination, such as 23-16-37, is replaced with a dynamic personalized combination based entirely on user history data as described above. For example, in FIG. 3A, “Beth”, is an answer to the example topic 180 “Best friend”, perhaps a current or former best friend of the user, as shown in FIG. 1. However, rather than use a set number-based combination dial 125 as shown in FIG. 1, the user is presented with the topic dial 325 having personalized indicators 326 that include potential user best friend names (one of which being “Beth”).

Moving to FIG. 3B, we see that a shape-based topic dial 355 is now aligned with the user's favorite shape (the personalized indicator 356 of an arrow). That is, this dial 355 has been rotated as described hereinabove to achieve the indicated alignment. Thus, the enter button 160 may be pressed, for example to lock or fix these initial dials 325, 355 in place. Next, additional alignment may be achieved by rotation of the outermost dial 375, a “Dream Vacation” topic dial with the underlying “Beth” 326 and arrow 356 personalized indicators. For example, continuing with the example above, the Bora Bora indicator 377 may be rotated around about 180° C. to attain such an alignment. Further, one or more additional topic dials may be present where the combination is to have more than two entries of alignments.

Again, while a user may bear witness to the alignments represented by FIGS. 3A and 3B, in subsequent attempts to access underlying secure data, the topic dials 325, 355, 375 may be of entirely new topics with or without reshuffled arrangements of indicators 326, 356, 376. Thus, attempts to gain access with knowledge largely limited to a prior vast amount of decoy alignments would likely remain futile. Once more, the user need not even recall an underlying combination such as 23-16-37 in order to gain access to the secure data Rather, recall of his own personal history and designated favorites would be enough to attain access.

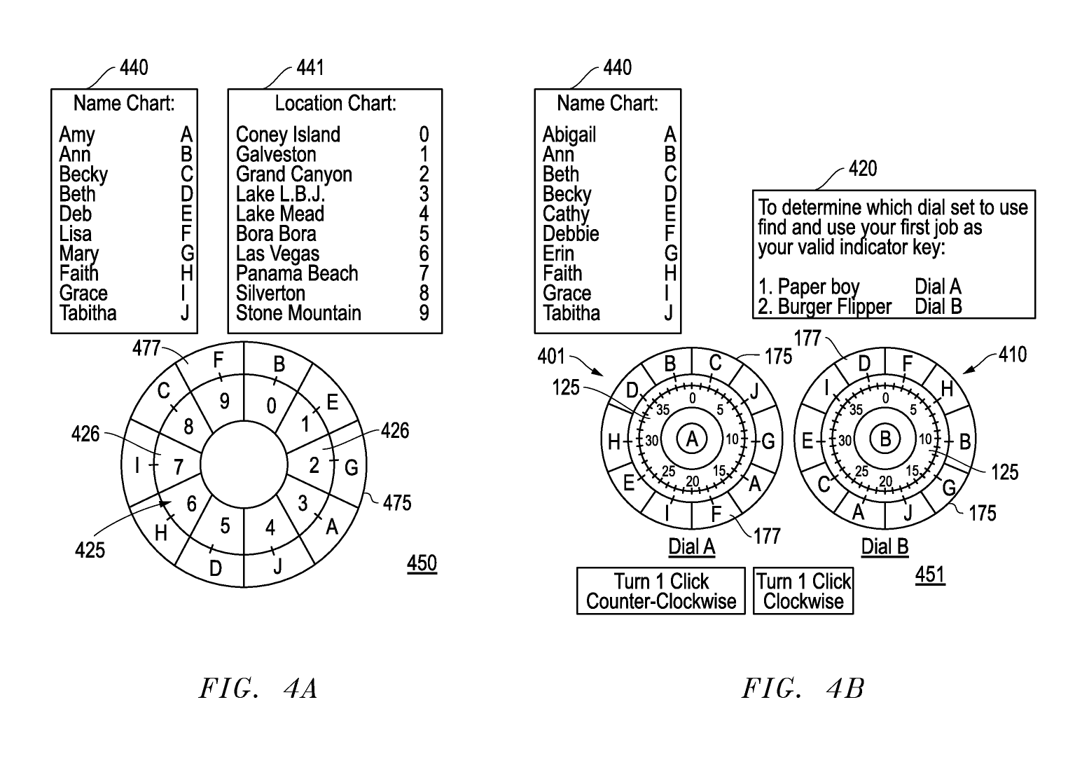

Referring now to FIG. 4A, a GUI 450 is shown in which the dials 425 and 475 are both topic dials as described above. Further, topic charts 440, 441 are presented to the user as an aid in furthering an alignment. For example, the personalized indicator 477 of “Beth” (D) may be aligned with the indicator 426 of “Bora Bora” (5) as shown. Thus, once this entry is made, a new pair of topic dials 425, 575 may be presented to the user for alignment and entry. Again, in this manner, the user need not recall a pre-set combination such as 23-16-37 in order to attain access to secure data and yet a passerby would be unable to lift the mode of access for later use and theft. However, in another embodiment, multiple topic lists 440, 441 may be presented where one is a decoy entirely. For example, the number dial 425 may actually be one of set indicators as shown in FIGS. 1 and 2A-2C but appear to be topic oriented to a passerby. Thus, the user may merely be entering a conventional combination number via alignment with a counter-combination topic dial 475 unbeknownst to an onlooker.

The concept of decoy may also be taken a step further such that an entire dial set 401 or 410 is a decoy. Specifically, as shown in FIG. 4B, a GUI 451 is shown where one entire dial set, 410 in this case, is a decoy based on a given topic 420 (e.g. the user's first job). Thus, the user may click buttons 260, 265 rotating both counter combination dials 175 of adjacent dial sets 401, 410 based on a topic 440 such, as that of FIG. 1. Yet, an onlooker is unable to detect what alignment is truly being made by the user. Indeed, 2, 3 or more decoy dial sets may be used depending on the number of possible answers to the given topic 420 in addition to the true dial set 401.

Referring now to FIG. 5, a representation of a GUI 550 is shown for an embodiment of a secure access data technique employing linear personalized combination pairings. That is, alignment need not be between adjacent dials. Rather, any adjacently disposed compartmentalized strings of data may be utilized. As shown in FIG. 5, this includes adjacent rows 525, 575 of data that may be moved relative one another via conventional slide 501. Further, in addition to, or in conjunction with, linear combination pairings, pairings may be made through overlay techniques where linear or other data arrangements are brought into alignment by overlaying one data set over another (e.g. via touch screen or mouse movement of data sets).

In the embodiment shown, all data compartments are personalized indicators 526, 577. However, one or both may alternatively be set indicators such as with a more conventional combination type as in the embodiments of FIGS. 1 and 2A-2C. Regardless, just as with other techniques detailed hereinabove, an alignment may be made that includes a majority of decoy alignments and one true alignment followed by pressing an enter button 160. Thus, new topic 580 and rows 525, 575 may be presented to the user for new alignment and entry. In this manner a sequence of entered alignments may be used to provide user access to secure data in a manner substantially undetectable to an onlooker or keystroke tracking virus.

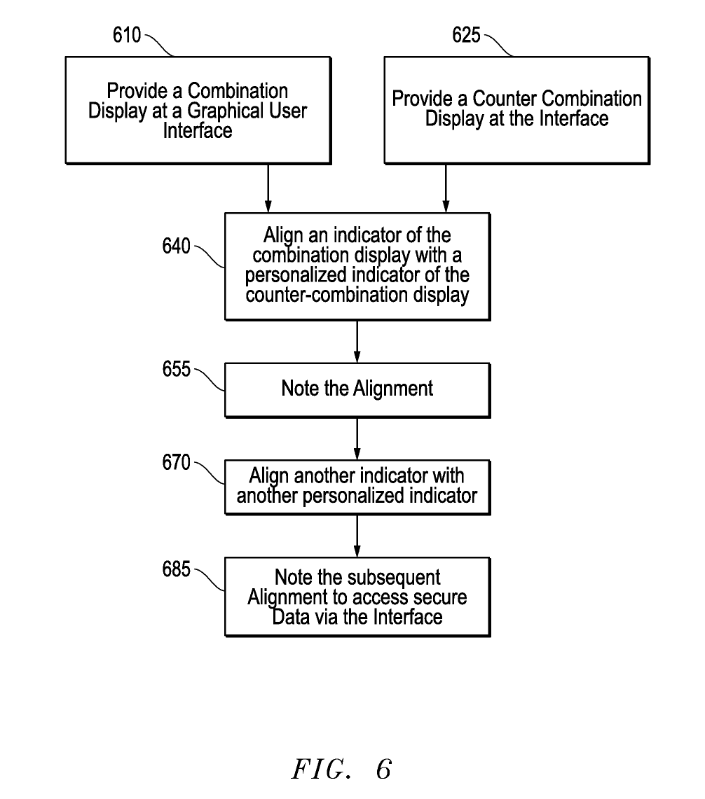

Referring now to FIG. 6, a flow-chart summarizing embodiments of employing secure data access techniques through graphical user interfaces is shown utilizing personalized pairings or alignments. As indicated at 610 and 625 multiple combination displays are provided. For example, a set combination display and personalized counter-combination display may be provided in dial form as depicted at FIG. 1 and elsewhere. However, linear displays may be used. Additionally, all groupings of compartmentalized data may be of a personalized nature as opposed to utilizing pre-set indicators (e.g. see FIGS. 3A, 3B and 5). Regardless, initial valid alignments are made between indicators of adjacent displays as indicated at 640 and the alignment entered as indicated at 655. However, as this occurs, all other aligning is of a decoy fashion so as to safeguard the entry from an onlooker or key tracking virus. The process is then repeated with new indicator pairings or alignments. That is, another indicator, of the original or subsequent combination display, is then aligned with another personalized indicator as indicated at 670. Ultimately, entry of the appropriate number of sequential alignments grants user access to underlying secure data through the interface as indicated at 685.

Embodiments described hereinabove provide added levels of security when entering passwords for sake of accessing secured data. The techniques employed allow the user to enter password characters in a manner that is substantially undetectable to an onlooker, whether physically present or even in the form of keystroke tracking type of virus applications. Once more this is achieved in a manner that minimizes complexity for the user by allowing reliance on a sequence of unique personal information entries that are unlikely to be uncovered even by someone that knows the user. Thus, the amount of time capital and even brain-space that must be dedicated to identity protection, password security and recollection may be dramatically reduced.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Regardless, the foregoing description should not be read as pertaining only to the precise structures described and shown in the accompanying drawings, but rather should be read as consistent with and as support for the following claims, which are to have their fullest and fairest scope.

I claim:

1. A method of accessing secure data through a graphical user interface, the method comprising:
aligning a first set indicator of a combination display grouping with a first personalized indicator of a first counter-combination display grouping;
noting said aligning as a valid alignment through entry at the interface;
aligning a second set indicator of the combination display grouping with a second personalized indicator of a second counter-combination display grouping;
noting said aligning of the second set indicator with the second personalized indicator as a valid alignment through entry at the interface; and
providing access to a user of the secure data based on entry of the valid alignments.

2. The method of claim 1 wherein the counter-combination display groupings are of personalized indicators based on personal history data of the user.

3. The method of claim 2 wherein the personal history data for the first counter-combination display and indicators corresponds to a different personal history data topic from that for the second counter-combination display and indicators.

4. The method of claim 2 further comprising storing personal history data of different topics with a host that retains the secure data in advance of the accessing of the secure data therefrom.

5. The method of claim 1 wherein said providing of the access to the user takes place in a public space.

6. The method of claim 1 wherein the first combination and counter-combination display groupings are a first set of groupings, the method further comprising presenting a second set of combination and counter-combination display groupings during said aligning of the first set indicator and first personalized indicator.

7. The method of claim 6 further comprising covertly alerting the user to employ the first set indicator and first personalized indicator to achieve the valid alignment.

8. The method of claim 1 wherein the combination display grouping and the first counter-combination display grouping are each one of a dial-type groupings adjacent one another, linear-type groupings adjacent one another and groupings for overlay alignment adjacent one another.

9. The method of claim 1 further comprising visually replacing the first counter-combination display grouping at the interface with the second counter-combination display grouping upon noting of said aligning of the first set indicator with the first personalized indicator.

10. A method of accessing secure data through a graphical user interface, the method comprising:
aligning a first indicator of a combination display grouping with a first indicator of a first counter-combination display grouping;
noting said aligning as a valid alignment through entry at the interface;
aligning a second indicator of a second combination display grouping with a second indicator of a second counter-combination display grouping;
noting said aligning of the second indicator of the second combination display grouping with the second indicator of the second counter-combination display grouping as a valid alignment through entry at the interface; and
providing access to a user of the secure data based on entry of the valid alignments.

11. The method of claim 10 wherein each of the indicators of the first and second combination and counter-combination display groupings are personalized indicators based on personal history data of the user.

12. A display device having a graphical user interface for a presentation comprising:
a combination display grouping of set indicators;
a counter-combination display grouping of personalized indicators adjacent the combination display grouping; and
an enter feature for noting a predetermined valid alignment of a given set indicator with a given personalized indicator.

13. The display device of claim 12 wherein the counter-combination display grouping is a first counter-combination display grouping, the presentation further comprising a second counter-combination display grouping with a given personalized indicator for alignment with another set indicator of the combination display.

14. The display device of claim 13 wherein the second counter-combination display grouping is rendered at the presentation after the noting to visually replace the first counter-combination display at the presentation.

15. The display device of claim 12 wherein in the interface is one of a touch-screen and mouse-click variety.

16. The display device of claim 12 being one of a tablet, a smartphone, a laptop, a desktop computer, an automated teller machine and a ticket kiosk.

17. The display device of claim 12 wherein said combination and counter-combination display groupings are of dial-form.

18. The display device of claim 17 wherein the presentation further comprises a turn button for visual rotation of at least one of the display groupings for the alignment.

19. The display device of claim 12 wherein said combination and counter-combination display groupings are of linear-form.

20. The display device of claim 19 wherein the presentation further comprises a slide feature for linear movement of at least one of the display groupings for the alignment.
